(19) United States
(12) Patent Application Publication
(10) Pub. No.: US 2007/0152442 A1
(43) Pub. Date: Jul. 5, 2007

(54) Brazeless connector for fluid transfer assemblies

(75) Inventors: Rafael L. Cleveland, Summerfield, FL (US); Terrence E. Skiba, Ocala, FL (US); Herbert R. Lemaster, Ocala, FL (US)

Correspondence Address: DAYCO PRODUCTS, LLC, 1 PRESTIGE PLACE, MIAMISBURG, OH, 45342, US

(73) Assignee: DAYCO PRODUCTS, LLC

(21) Appl. No.: 11/712,457

(22) Filed: Feb. 28, 2007

Related U.S. Application Data
(63) Continuation-in-part of application No. 11/331,295, filed on Jan. 12, 2006.
Application No. 11/331,295 is a division of application No. 10/170,749, filed on Jun. 13, 2002, now abandoned.

(51) Int. Cl. F16L 33/00

(52) U.S. Cl. 285/256

(57) ABSTRACT

A metal end fitting connector having an axial bore through which a fluid is conveyed; comprises a metal stem portion which includes a first metal tubular body having a first annular rim disposed at a distal end of the first metal tubular body, wherein the distal end is adapted to be inserted into an inner channel of a metal fluid transport tube. The metal stem portion includes at least one annular sealing member extending circumferentially outward from an outer surface of the first metal tubular body; and a metal connector portion opposite the distal end of the first metal tubular body. The metal connector portion includes a second metal tubular body having a second annular rim disposed at a distal end of the second metal tubular body, wherein the distal end of the second metal tubular body is adapted to be coupled with another fluid conveying structure.

This application is continuation-in-part of U.S. patent application Ser. No. 11/331,295, filed Jan. 12, 2006, which is a division of U.S. patent application Ser. No. 10/170,749, filed Jun. 13, 2002, now abandoned.

### BACKGROUND OF THE INVENTION

The present invention relates to a coupling device for tubing connections and method for connecting tubes using such coupling devices. More specifically, the present invention relates to the connection of a metal fluid transfer tubing to other metallic connections without having to braze or weld the two pieces together.

Hose coupling devices are known. For example, U.S. Pat No. 3,653,692 to Henson describes an elastomeric hose connected to a nipple having a circumferential barb. The hose is stretched allowing a ring member to slide down the hose and over the barbed nipple where it creates a compression of the hose when the hose is no longer stretched. U.S. Pat. No. 3,477,750 to Powell discloses a pipe section joined by a sleeve, which includes annular teeth. The pipe is made of iron and the sleeve is preferably made of the same material. The design requires an additional sealing means in the form of a thin elastomeric membrane and further requires that the teeth be formed onto the pipe one at a time. U.S. Pat No. 3,689,111 to Osmun; U.S. Pat. No. 5,707,087 to Ridenour et al.; U.S. Pat. No. 4,114,930 to Perkins et al.; and U.S. Pat. No. 5,423,581 to Salyers all teach coupling devices for connecting tubing to a fitting assembly to prevent leaks.

Current practice in the tube connector art requires that a heavy clamping or crimping force be applied about a collar around the tube and the fitting to provide a fluid-tight seal and to provide pull-off resistance to the assembly. In such cases, the tube is compressed radially inward to make a seal. However, it is difficult to make a permanent leak-tight seal, because the tube, even though malleable, tends to have sufficient elasticity to relax somewhat and deform, upon release of the clamping or crimping pressure just enough to compromise the fluid-tight seal, particularly, when the fluid is under high pressure for an extended period of time.

End connections on fluid transfer assemblies such as on power steering pressure and return lines require tight tolerances and high strength to prevent the fluid from leaking from the assembly. Conventional connectors are not able to achieve the required tolerances or the strength required to prevent such leaks, Typically, these connectors are brazed or welded to the fluid transfer tubing. When an assembly is brazed, it undergoes high temperatures which are generally detrimental to any coating or plating on the assembly or on the tubing. When steel or other low corrosion tolerance material is used as the assembly material, the assembly must be treated in order to protect it from the environment. Typical methods of treatment include electroplating and painting. Such methods are generally not desirable because the coating often flakes during bending which leads to high scrap rates.

Another common coupling includes a metal housing which receives a metal male fitting having a circumferential flange. The housing typically includes an 0-ring for sealing the male fitting therein. The male fitting is secured within the housing by a plurality of spring-loaded detents which spring open to allow the insertion of the male fitting and then spring closed to prevent withdrawal of the fitting from the tube. However, this type of assembly is susceptible to “end play” of the fitting which leads to failure of the seal.

Therefore, it would be advantageous to have a connector for fluid transfer assemblies which eliminate the drawbacks of previously known connector assemblies.

### SUMMARY OF THE INVENTION

It is an object of the present invention to provide a pre-coated metal tube and metal connector assembly, and method for providing such assembly which is leak- free at high pressure for extended periods of time.

In accordance with the present invention, a tube connector is used to connect a fluid transfer tubing to other metallic connections in a manner to provide a leak-free fluid transfer assembly. The tube connector comprising a rigid tubular member having an annular channel exhibiting a uniform inner diameter extending along its longitudinal axis for transporting a fluid therethrough. The rigid tubular member comprises a first end portion, a second end portion and a tubular body portion. The tube connector further includes an axial bore which is adapted to convey a fluid therethrough. The first end portion includes a stem portion having a uniform outer surface diameter adapted to be inserted into an inner channel of a metal tubular structure, the stem portion having at least one sealing means extending uniformly outward from the outer surface diameter of the stem portion.

The second end portion includes a forward tubular structure which may or may not have a uniform outer diameter. The tubular body portion intermediate the first and second ends has an outer diameter larger than the second end. Typically, the rearward end of the tubular body portion has a surface perpendicular to the tubular portion of the second end forming a perpendicular shoulder against which the end of the metal tubular structure abuts upon insertion of the tube connector into the channel of the metal tubular structure, wherein the second end of the rigid tubular member is sealably secured to the metal connector by permanently and uniformly deforming the metal tubular structure under high pressure onto the sealing members.

In one embodiment of the present invention, a metal fitting pre-coated with a thin metallic coating such as zinc-nickel or zinc-cobalt is provided with one or more concentric annular metal barbs on the outer diameter of the metal fitting. The metal fitting is then loosely inserted into the end of the metal tube where the fitting is joined to the tube in a fluid-tight seal created by crimping, swaging, rolling or other means of permanently deforming the metal tube uniformly around the metal barbed fitting. The fluid-tight seal is created by the high pressure of the metal annular barbs pressed against the inner diameter of the metal tube, wherein the inner surface of the pre-coated metallic tube is permanently deformed corresponding to the configuration of the metal annular barbs on the metallic filling. The sealing is further enhanced by the permanent deformation of the inner diameter of the metal tube as it molds itself around the metal barbs, providing an intimate surface- to- surface relationship created between the two surfaces. In this respect, it is important that both the metal tube and the metal barbs on the fitting exhibit similar hardness and thermal expansion rate characteristics in order to create a leak free seal. Similar characteristics allow for the materials to flow and fill any voids or leak paths which may tend to form. The similar metallic materials also provide good leak resistance with respect to temperature and pressure variations.

### BRIEF DESCRIPTION OF THE DRAWING

FIG. 1 is a longitudinal view, in cross section, of a tube connector of the present invention ready for assembly with a metal, fluid transfer tube;

FIG. 2 is a longitudinal view, in cross section of the tube connector of FIG. 1 assembled with a metal fluid transfer tube;

FIG. 3 is a longitudinal view, in a cross section of the assembly of FIG. 2 wherein the metal, fluid transfer tube is compressed on the tube connector by a compressor means;

FIG. 4 is a longitudinal view, in cross section of another embodiment of the present invention;

FIG. 5 is a longitudinal view, in cross section of a tube of yet another aspect of the invention assembled with a metal fluid transfer tube; and

FIG. 6 is a longitudinal view, in cross section of a tube of still another aspect of the invention assembled with a metal fluid transfer tube..

### DETAILED DESCRIPTION OF THE INVENTION

In accordance with the present invention, a metal tube connector is permanently coupled to a metal fluid transfer tube to provide a leak-free metal tube assembly, such as those used in automotive power steering assemblies, air conditioning assemblies, etc., without having to weld or braze the two pieces together. Since the present invention does not require the high temperatures associated with prior methods of coupling a metal connector to a metal tubing, the metal tubing may be pre-coated prior to making the assembly.

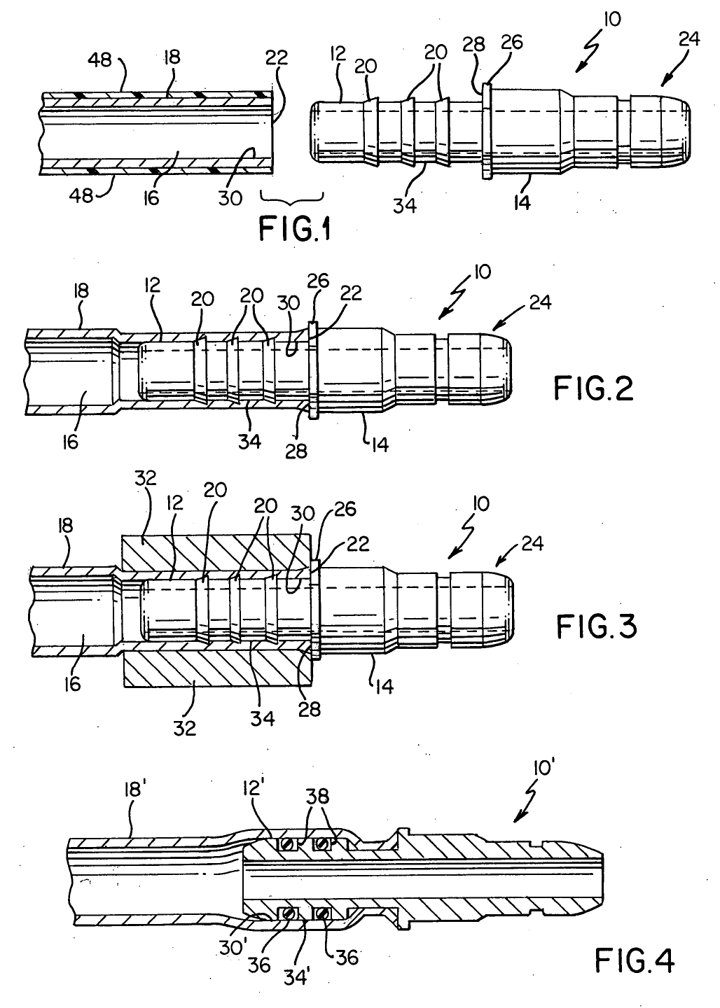

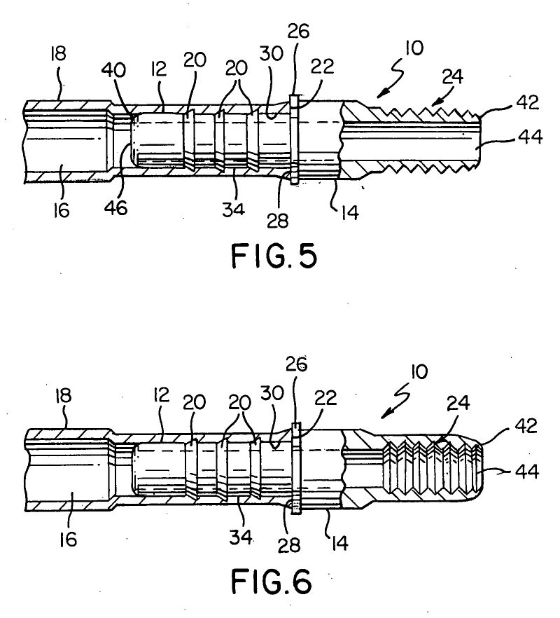

As illustrated in FIGS. 1 and 2, the metal end fitting 10 of the first embodiment of the present invention includes a stem portion 12 defining one end of the end fitting 10 and a coupling portion 14 defining another end of the end fitting 10. The stem portion 12 is adapted to be inserted into an end 22 of an inner channel 16 of a metal tubular structure 18 and secured thereto to provide a leak-free fitting.

The stem portion 12 includes an annular rim 40 defining an annular opening 46, and one or more annular serrations or barbs 20 circumferentially disposed around the outer circumference of the stem portion 12. The stem portion 12 containing the serrations or barbs 20 is loosely inserted into the end 22 of the metal tubular structure 18 and subjected to crimping, swaging, rolling or other method of permanently deforming the metal tubing 18 uniformly onto the stem portion 12. The leak-free seal is created by the high pressure exerted upon the metal tubular structure 18 wherein the annular serrations or barbs 20 are pressed against and into the inner surface 44 of the metal tubular structure 18. The sealing is further enhanced by the permanent deformation of the inner diameter of the metal tubing 18 as it molds around the annular serrations or barbs 20, creating an intimate mating of both surfaces. It is essential that the metal tubular structure 18 and the serrations or barbs 20 have the same or similar characteristics such as hardness and thermal expansion rates in order for the seal to be leak-free. Similar hardness of the metal materials used in the metal tubular structure 18 and in the serrations or barbs 20 allow both metal materials to exhibit similar flow characteristics and, therefore, fill any potential voids or leak paths. Furthermore, both materials should have similar thermal expansion rates, otherwise, they may be prone to leaks upon being exposed to temperature variations. Typically, the metal tubular structure is constructed of a low corrosion tolerance material, such as steel or the like which is pre-coated to prevent corrosion. Other materials having properties similar to the material used in forming the barbs may be employed to form the tubular structure.

The material used in manufacturing the tubular structure 18, the stem portion 12 and the serrations or barbs 20 of the present invention should be high quality and free of voids, pits, laps, cracks, folds, seams, slivers and other defects. When using these metal materials in the assemblies, they must be treated to protect the metal from the environment. Typical methods of treatment include electro plating and painting. Since the electro plated or similar treated connectors usually cannot withstand the high temperatures associated with brazing or welding, it has been very difficult to achieve a leak-free connection between a metal fluid transfer tube and other metallic connections using conventional techniques. Connections made in accordance with the present invention do not require high temperature; therefore, pre-treated metal tubes can be connected to an end fitting without the disadvantages associated with the prior art. See, for example, FIG. 1 where the outer surface of tubular structure 18 is illustrated as being pre-coated with protective coating 48 to protect the tubular structure 48 from environmental conditions. Both the tubular structure 18 and the end fitting connector 10 can be pre-coated with the protective material if desired.

The serrations or barbs 20 on the stem portion 12 should be as sharp as the machining operation can make them to provide an adequate seal. It is also important that the serrations or barbs 20 be concentric to insure an even and constant penetration of the serrations or barbs 20 into the metal tubular structure 18 upon being crimped, swaged, rolled, etc under high pressure. The pressure needed to deform the tubular structure may be applied by suitable compression means 46′ such as hydraulics, air-over-hydraulics, pneumatic or any other suitable method (see FIG.3).

The shape of the serrations or barbs 20 is also important in providing the leak-free seal. The serrations or barbs 20 are tapered to extend outwardly from the outer surface 34 providing a forward rim defining a circumferential apex of an annular shoulder surface of the rim to provide a leak-free seal.

The number of serrations or barbs 20 present on the stem portion 12 is not critical. One serration or barb is sufficient in most applications; however, one may want to employ a plurality of serrations or barbs to provide backup seals in the assembly. Typically, 2 or 3 serrations or barbs are preferred.

The metal coupling portion 14 of the metal end fitting 10 includes a connecting portion 24 extending longitudinally outward from the stem portion 12. The connecting portion 24 connects the coupling portion 14 to a mated fitting (not shown). Typically, the connecting portion 14 includes flanged portion 26 adapted to receive a tool, such as a wrench, to hold the coupling portion 14 as the end fitting 10 is being connected to the mated fitting. The flanged portion 26 defines a rear shoulder surface 28. The connecting portion 24 can further include a threaded portion (not shown) extending longitudinally outward from the flanged portion 24. The threaded portion can comprise a male threaded portion or a female threaded portion. Additionally, the metal coupling portion 14 can include any suitable coupling mechanism, such as a quick disconnect type fitting, or other types of conventional coupling mechanisms known in the art.

When the metal end fitting 10 is inserted into the metal tubular structure 18, the metal tubular structure 18 is compressed radially inward around the stem portion 12 of the end fitting 10 such that the inner channel 16 of the tubular structure 18 engages the serrations or barbs 20 providing a leak-free seal at each of the serrations or barbs 20. The serrations or barbs 20 not only provide leak-free seals but the also increase the pull-off resistance of the end fitting assembly 10.

Another embodiment of the invention is shown ion FIG. 4, where the stem portion 12′ of end fitting 10′ includes one or more annular troughs 32′ around the outer surface 34′ of the stem portion 12′. Each of the annular troughs 32′ is adapted to contain an O-ring member 36′, the outer diameter of which is slightly greater than the outer diameter of the stem portion 12′. The O-ring member 36′ is made of a resilient material such as butyl rubber, nitrile-butadiene rubber, hydrogenated nitrile-butadiene rubber, silicone rubber, CSM or other appropriate material for the fluid being retained..

When the stem portion 12′ is inserted into an open end of a metal tubular structure 18′ and then subjected to high pressure means to clamp the metal tubular structure 18′ around the stem 12′, the resilient O-rings 36′ are compressed to form an intimate contact with the inner surface 44′ of the tubular structure 18′ as well as the annular trough 32′ providing a leak-free seal therein. This second embodiment of the invention allows one to use materials for the metal connector and the metal tubular structure which are not required to be similar in hardness or in thermal expansion rate. For example, in this embodiment the metal connector may be made of steel and the metal tubular structure may be aluminum.

It is to be understood that any reference to metal materials employed herein includes metal alloys and/or mixtures of metals.

Although the present invention has been fully described in connection with a preferred embodiment thereof and with reference to the accompanying drawings, various changes and modifications will occur to those skilled in the art. Accordingly, such changes and modifications are to be understood as being within the scope of the present invention as defined by the appended claims.

What is claimed is:

1. In combination with a first metal fluid transport tube and a second fluid transport member, a metal end fitting connector having a first end configured to mate with an inner surface of said first fluid transport tube, and a second end configured to couple with said second fluid transport member, said metal end fitting connector having an axial bore through which fluid is conveyed, said metal end fitting connector comprising:
a metal stem portion having an outer surface exhibiting a uniform circumference and a first annular rim at a distal end thereof, said first annular rim defining a first orifice of said axial bore, wherein said metal stem portion is adapted to be inserted into an inner channel of said first metal fluid transport tube, wherein said outer surface of said metal stem portion mates with said inner surface of said first metal fluid transport tube, said metal stem portion including one or more annular sealing members on said outer surface of said metal stem portion, said metal stem portion being permanently sealed to said first metal fluid transport tube to provide a leak-free seal between said metal stem portion and said first metal fluid transport tube, with the proviso that said end fitting connector is permanently sealed said metal fluid transport tube in the absence of a snap ring;
a metal portion opposite said metal stem portion, said metal connector portion having a second annular rim at a distal end thereof, said second annular rim defining a second orifice of said axial bore, wherein said metal connector portion further comprises a coupling means adapted to be coupled to said second metal fluid transport member, wherein said coupling means is one of an externally threaded coupler member capable of engaging a corresponding internally threaded coupler member, an internally threaded coupler member capable of engaging a corresponding externally threaded coupler member, and a quick connect/disconnect coupler member capable of engaging a corresponding coupler member; and
a tubular body portion intermediate said metal stem portion and said metal connector portion, said tubular body portion having a shoulder portion exhibiting a surface area perpendicular to said outer surface of said metal stem portion, such that a distal end of said fluid transport tube abuts said shoulder portion, said outer surface of said metal stem portion having a uniform circumference extending from said first annular rim to said perpendicular surface area of said shoulder portion.

2. The end fitting connector of claim 1, wherein said one or more annular sealing members comprises one or more metal barbs integral with and extending circumferentially outward from said outer surface of said metal stem portion, each of said one or more metal barbs having a forward rim exhibiting a sharp edge defining a circumferential apex of an annular shoulder surface of said each of said metal barbs, said inner surface of said metal fluid transport tube being uniformly deformed on and around said one or more metal barbs to create a leak-free seal between said metal stem portion and said metal fluid transport tube during wide variations in temperature.

3. The end fitting connector of claim 2, wherein said metal stem portion, said one or more metal barbs and said metal fluid transport tube are made from metals or metal alloys having a similar hardness and a similar thermal expansion rate.

4. The end fitting connector of claim 3, wherein said metal stem portion, said one or more metal barbs and said fluid transport tube are made from steel.

5. The end fitting connector of claim 4, wherein said metal stem portion, said one or more metal barbs and said metal fluid transport tube are made of aluminum.

6. The end fitting connector of claim 1, wherein said metal end fitting connector further comprises a thin metallic coating selected from the group consisting of zinc-nickel and zinc-cobalt.

7. The end fitting connector of claim 1, wherein said annular sealing member is one or more resilient members selected from the group consisting of butyl rubber, nitrile-butadiene rubber, hydrogenated nitrile-butadiene rubber, silicone rubber, chlorosulfonated polyethylene and ethylene-propylene-diene rubber.

8. The end fitting connector of claim 7, wherein said one or more resilient members is seated in corresponding grooves disposed around said outer surface of said metal stem portion.

9. The end fitting connector of claim 1, wherein said metal fluid transport tube comprises a nylon coating.

10. In combination with a first metal fluid transport tube and a second fluid transport member, a metal end fitting connector having a first end configured to mate with an inner surface of said first fluid transport tube and a second end configured to couple with said second fluid transport member, said metal end fitting connector having an axial bore through which fluid is conveyed, said metal end fitting connector comprising:
a metal stem portion comprising an outer annular surface exhibiting a uniform circumference, one or more metal annular barbs integral with and extending circumferentially outward from said annular surface, and a first annular rim at a distal end of said metal stem portion, said first annular rim defining a first orifice of said axial bore, said metal stem portion being adapted to be inserted into an inner channel of said metal fluid transport tube, said inner channel of said metal fluid transport tube comprising an inner surface having a uniform circumference corresponding to said uniform outer circumference of said metal stem portion, said metal fluid transfer tube being uniformly deformed on and around said one or more metal barbs to create a permanent leak-free seal between said metal stem portion and said metal fluid transport tube, with the proviso that said end fitting connector is permanently sealed to said metal fluid transport tube in the absence of a snap ring;
a metal connector portion opposite said metal stem portion, said metal connector portion having a second annular rim at a distal end thereof, said second annular rim defining a second orifice of said axial bore, wherein said metal connector portion comprises a coupling means adapted to be coupled to said second metal fluid-conveying member, wherein said metal coupling means is one of an externally threaded coupler member capable of engaging a corresponding internally threaded coupler member, an internally threaded coupler member capable of engaging a corresponding externally threaded coupler member, and a quick connect/disconnect coupler member capable of engaging a corresponding coupler member; and
a tubular body portion intermediate said metal stem portion and said metal connector portion, said tubular body portion having a shoulder portion exhibiting a surface area perpendicular to said outer surface of said metal stem portion, such that a distal end of said metal fluid transport tube abuts said shoulder portion, said outer surface of said metal stem portion having a uniform circumference extending from said first annular rim to said perpendicular surface area of said shoulder portion.

11. The metal or metal alloy end fitting connector of claim 10, wherein said metal stem portion, said one or more metal barbs and said metal fluid transport tube are made from steel or aluminum.

12. The metal end fitting connector of claim 11, wherein said metal fluid transport tube comprises a nylon coating on the outer surface thereof.

13. A metal end fitting connector having a first end configured to mate with an inner surface of said first fluid transport tube, and a second end configured to couple with said second fluid transport member, said metal end fitting connector having an axial bore through which fluid is conveyed, said metal end fitting connector comprising:
a metal stem portion having an outer surface exhibiting a uniform circumference and a first annular rim at a distal end thereof, said first annular rim defining a first orifice of said axial bore, wherein said metal stem portion is adapted to be inserted into an inner channel of said first metal fluid transport tube, wherein said outer surface of said metal stem portion mates with said inner surface of said first metal fluid transport tube, said metal stem portion including one or more annular sealing members on said outer surface of said metal stem portion, said metal stem portion being permanently sealed to said first metal fluid transport tube to provide a leak-free seal between said metal stem portion and said first metal fluid transport tube, with the proviso that said end fitting connector is permanently sealed said metal fluid transport tube in the absence of a snap ring;
a metal portion opposite said metal stem portion, said metal connector portion having a second annular rim at a distal end thereof, said second annular rim defining a second orifice of said axial bore, wherein said metal connector portion further comprises a coupling means adapted to be coupled to said second metal fluid transport member, wherein said coupling means is one of an externally threaded coupler member capable of engaging a corresponding internally threaded coupler member, an internally threaded coupler member capable of engaging a corresponding externally threaded coupler member, and a quick connect/disconnect coupler member capable of engaging a corresponding coupler member; and
a tubular body portion intermediate said metal stem portion and said metal connector portion, said tubular body portion having a shoulder portion exhibiting a surface area perpendicular to said outer surface of said metal stem portion, such that a distal end of said fluid transport tube abuts said shoulder portion, said outer surface of said metal stem portion having a uniform circumference extending from said first annular rim to said perpendicular surface area of said shoulder portion.

14. The end fitting connector of claim 13, wherein said one or more annular sealing members comprises one or more metal barbs integral with and extending circumferentially outward from said outer surface of said metal stem portion, each of said one or more metal barbs having a forward rim exhibiting a sharp edge defining a circumferential apex of an annular shoulder surface of said each of said metal barbs, said inner surface of said metal fluid transport tube being uniformly deformed on and around said one or more metal barbs to create a leak-free seal between said metal stem portion and said metal fluid transport tube during wide variations in temperature.

15. The end fitting connector of claim 14, wherein said metal stem portion, said one or more metal barbs and said metal fluid transport tube are made from metals having a similar hardness and a similar thermal expansion rate.

16. The end fitting connector of claim 15, wherein said metal stem portion, said one or more metal barbs and said fluid transport tube are made from steel or aluminum.

17. The end fitting connector of claim 13, wherein said metal end fitting connector further comprises a thin metallic coating selected from the group consisting of zinc-nickel and zinc-cobalt.

18. The end fitting connector of claim 13, wherein said annular sealing member is one or more resilient members selected from the group consisting of butyl rubber, nitrile-butadiene rubber, hydrogenated nitrile-butadiene rubber, silicone rubber, chlorosulfonated polyethylene and ethylene-propylene-diene rubber.

19. The end fitting connector of claim 18, wherein said one or more resilient members is seated in corresponding grooves disposed around said outer surface of said metal stem portion.

20. The end fitting connector of claim 13, wherein said metal fluid transport tube comprises a nylon coating.
